(19) United States
(12) Patent Application Publication
(10) Pub. No.: US 2026/0105324 A1
(43) Pub. Date: Apr. 16, 2026

(54) INFORMATION PROCESSING SYSTEM, CONTROL METHOD OF INFORMATION PROCESSING SYSTEM, AND STORAGE MEDIUM

(71) Applicant: CANON KABUSHIKI KAISHA, Tokyo (JP)

(72) Inventors: Kashu MATSUMOTO, Kanagawa (JP); Masakazu FUJIKI, Kanagawa (JP); Atsushi NOGAMI, Kanagawa (JP)

(21) Appl. No.: 19/352,610

(22) Filed: Oct. 8, 2025

(30) Foreign Application Priority Data
Oct. 11, 2024 (JP) 2024-179279

(51) Int. Cl. G06N 5/022

(52) U.S. Cl. CPC G06N 5/022

(57) ABSTRACT

An information processing system comprising: a holding unit configured to hold, in association with each other as evaluation information, a learned model and information indicating a degree of change in which a generation result generated by the learned model changes with respect to original data; a request acquisition unit configured to acquire request information representing a request regarding the degree of change; and a selection unit configured to select at least one learned model from among a plurality of learned models held in the holding unit based on the request information and the evaluation information.

### BACKGROUND

### Field of the Technology

The present disclosure relates to an information processing system, a control method of the information processing system, and a storage medium.

### Description of the Related Art

In recent years, with the spread of learned models learned for the purpose of data generation called generative AI, an environment enabling easy mass generation of various data (text, images, moving images, audio, 3D models, and the like) has been developed. Examples thereof include generation of news content and AI anchors in news shows in the mass media industry, and generation of AI celebrities and AI actors in the entertainment industry.

On the other hand, data generated by inference by the generative AI may include information contrary to facts. As the accuracy of the generative AI is improved, it becomes very difficult for those other than the data creator to distinguish between factual information and non-factual information included in generated data. With the spread of generative AI, there is also an increasing problem that a data creator intentionally mixes information contrary to facts into generated data for the purpose of information manipulation or fraud.

Japanese Patent No. 7065266 discloses a technique of selecting a learned model satisfying performance and calculation resources from among a plurality of learned models. Specifically, the performance of each of the plurality of learned models is calculated using test data added with correct answer information, the learned model is selected based on the performance, and then the optimal learned model is selected based on resource information on a user side apparatus. This enables a learned model also in consideration of an execution environment for execution to be selected from among the plurality of learned models.

However, the technique described in Japanese Patent No. 7065266 enables a learned model to be selected in consideration of performance and calculation resources, but it is unclear how much the generation result of the selected learned model is based on factual information. Therefore, there is a problem that it is difficult to select a learned model that gives a generation result desired by the user.

### SUMMARY

The present disclosure has been made in view of the above problem, and provides a technique for easily selecting a learned model that gives a generation result desired by the user.

According to one aspect of the present disclosure, there is provided an information processing system comprising: a holding unit configured to hold, in association with each other as evaluation information, a learned model and information indicating a degree of change in which a generation result generated by the learned model changes with respect to original data; a request acquisition unit configured to acquire request information representing a request regarding the degree of change; and a selection unit configured to select at least one learned model from among a plurality of learned models held in the holding unit based on the request information and the evaluation information.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is an explanatory view of a scene in which an information processing apparatus according to first and third embodiments selects a learned model.

FIGS. 2A to 2C are views illustrating examples of a plurality of learned models recorded in a holding unit of the information processing apparatus according to the first and third embodiments.

FIG. 3 is a flowchart showing a flow of processing regarding veracity evaluation information recorded in a recording unit according to one embodiment.

FIGS. 4A to 4C are explanatory views regarding calculation of veracity according to one embodiment.

FIGS. 5A and 5B are explanatory views regarding a learned model that performs text-to-image.

FIG. 6 is a block diagram illustrating a hardware configuration of an information processing system according to one embodiment.

FIG. 7 is a block diagram illustrating a module configuration of the information processing system according to the first embodiment.

FIG. 8 is a flowchart showing a flow of processing executed by the information processing apparatus according to the first and second embodiments.

FIG. 9 is a view illustrating an example of veracity evaluation information to be acquired by an information processing apparatus according to one embodiment.

FIG. 10 is a flowchart showing a flow of veracity calculation processing according to the first embodiment.

FIG. 11 is an explanatory view of veracity calculation processing according to the first embodiment.

FIG. 12 is an explanatory view of a usage form of the information processing apparatus according to the second embodiment.

FIG. 13 is a block diagram illustrating a module configuration of the information processing system according to the second embodiment.

FIGS. 14A and 14B are views illustrating examples of veracity evaluation information to be acquired by the information processing apparatus according to the second embodiment.

FIG. 15 is a block diagram illustrating a module configuration of the information processing system according to the third embodiment.

FIG. 16 is a flowchart showing a flow of processing executed by the information processing apparatus according to the third embodiment.

FIG. 17 is a view illustrating an example regarding a display screen of a display UI system according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

First, an outline of an environment in which the information processing apparatus according to the first embodiment is used will be described. Here, a “degree representing how much a generation result by generative AI is based on facts” or a “degree of change in which a generation result by generative AI changes with respect to original data (change target information)” is defined as “veracity”. Alternatively, information indicating the degree to which a generation result by generative AI has not changed with respect to original data may be used. Alternatively, an index representing a processing degree with respect to original data, an alteration amount of the original data, a remaining degree of the original data, a deformation degree with respect to the original data, or the like may be used.

In the present embodiment, a situation of selecting a learned model based on the veracity requested by the user who generates an image will be described as an example.

### Usage Form

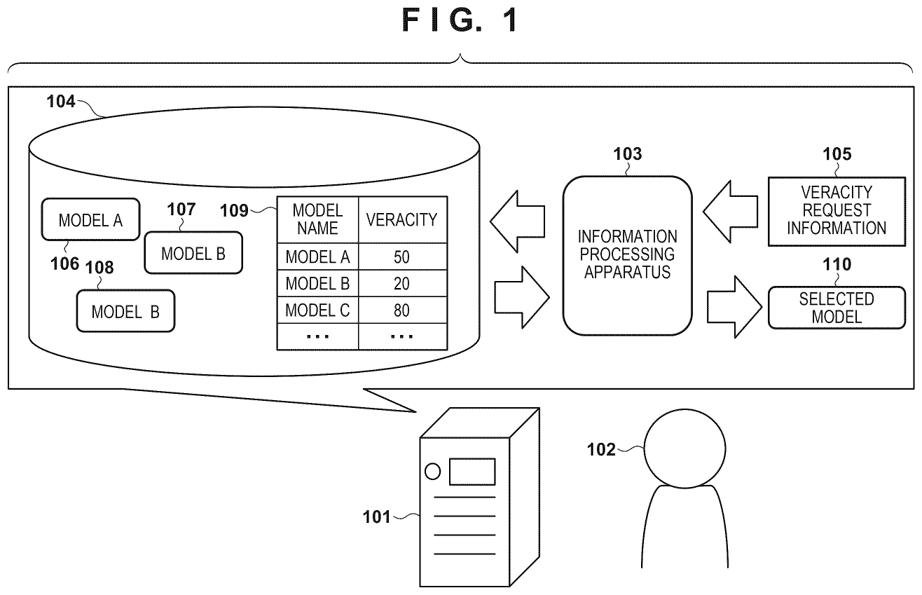

FIG. 1 is an explanatory view in which an information processing apparatus 103 according to the present embodiment selects a learned model recorded in a holding unit 104. A user 102 inputs veracity requested as veracity request information 105. The information processing apparatus 103 acquires veracity evaluation information 109 from the holding unit 104 in order to select a learned model suitable for the veracity request information 105 having been input. The veracity evaluation information in the present embodiment is a management table in which a model A 106, a model B 107, and a model C 108 recorded in the holding unit 104 are recorded in association with the veracity of the respective models. The information processing apparatus 103 selects a selected model 110 from the holding unit 104 based on the veracity evaluation information 109 having been acquired and the veracity request information 105 having been input. Note that although the information processing apparatus 103 and the holding unit 104 are depicted as separate bodies in the example of FIG. 1, the information processing apparatus 103 may be configured to include the holding unit 104.

### Learned Model

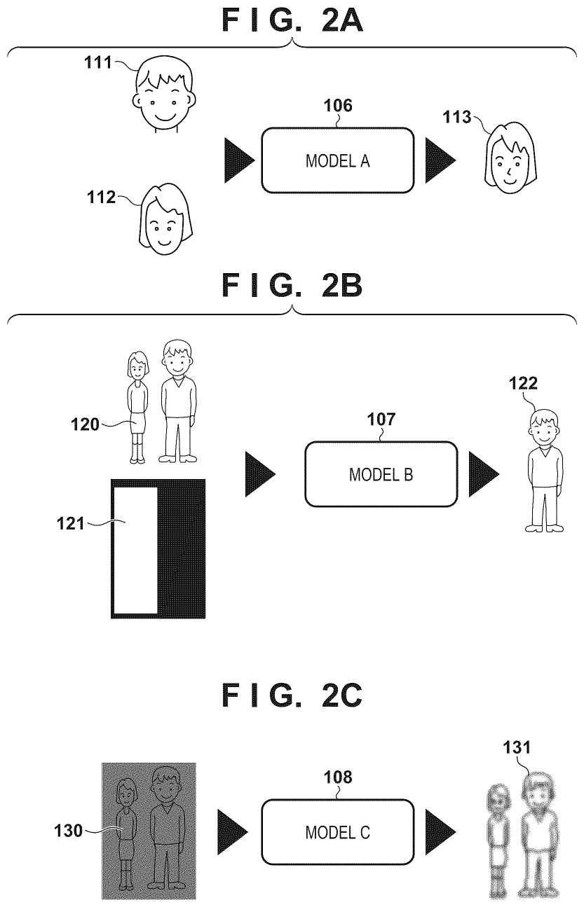

FIGS. 2A to 2C are explanatory views of examples regarding learning of a plurality of different learned models recorded in the holding unit 104. The model A 106 will be described with reference to FIG. 2A. The model A 106 is a model for performing style conversion, and specifically, outputs a style converted image 113 in which a person of an image input as a reference image 111 is made resemble a person input as a style image 112.

The model B 107 will be described with reference to FIG. 2B. The model B 107 is a model for deleting a local region, and specifically, outputs a region deleted image 122 based on an image in which a local region of an image input as a reference image 120 is input as a mask image 121. In the example of FIG. 2B, a region on the left side is deleted.

The model C 108 will be described with reference to FIG. 2C. This model C 108 is a model for removing noise, and specifically, detects and removes a noise component contained in an image input as a noisy image 130, and outputs a noise-free image 131.

The plurality of different learned models in the present embodiment may be CNN-based neural network models (hereinafter, the NN models), or may be GANs having a generator/discriminator. CNN is an abbreviation for convolutional neural network, and GAN is an abbreviation for generative adversarial network.

### Recording Processing of Veracity Evaluation Information

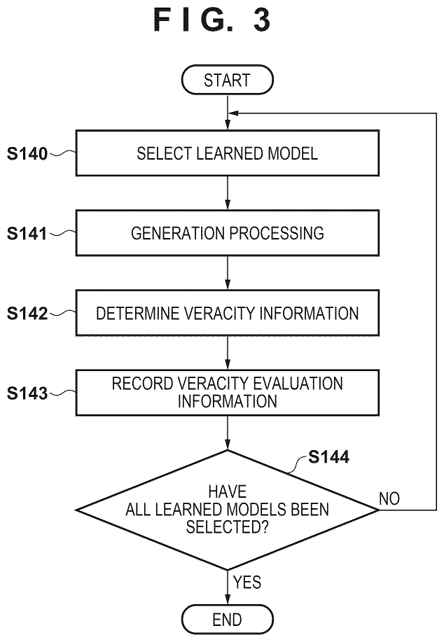

FIG. 3 is a flowchart showing a procedure of processing regarding recording of the veracity evaluation information 109 recorded in the holding unit 104 according to the present embodiment. The series of processing is executed by the information processing apparatus 103.

In step S140, the information processing apparatus 103 selects one learned model from among a plurality of learned models recorded in the holding unit 104. In step S141, the information processing apparatus 103 prepares, in advance, test data to be input, and performs generation processing by inputting the prepared test data to the learned model selected in step S140. As the test data, data recorded in the holding unit 104 in advance may be used, or data arbitrarily prepared by the user who has recorded the learned model into the holding unit 104 may be used. The test data may be assigned with correct answer information. The generation processing of the learned model in the present embodiment is assumed to generate an image. However, the generation target is not limited to images, and may be audio, text, 3D models, and the like.

In step S142, the information processing apparatus 103 calculates the veracity based on the result generated in step S141. A specific content of the calculation method of the veracity will be described later. In step S143, the information processing apparatus 103 records, as the veracity evaluation information 109, the learned model selected in step S140 and the veracity calculated in step S142 in association with each other. The recording method in the present embodiment is a table in which a learned model and veracity are associated with each other. However, the recording method is not limited to this, and the learned model and the veracity may be recorded in a mutually indexable form, and for example, the learned model and the veracity may be in a list form in which they are managed with the same index.

In step S144, the information processing apparatus 103 determines whether calculation of the veracity has been completed for all the learned models recorded in the holding unit 104. If the processing has been completed, the series of processing is ended. On the other hand, if the processing has not been completed, the processing returns to step S140.

### Calculation of Veracity

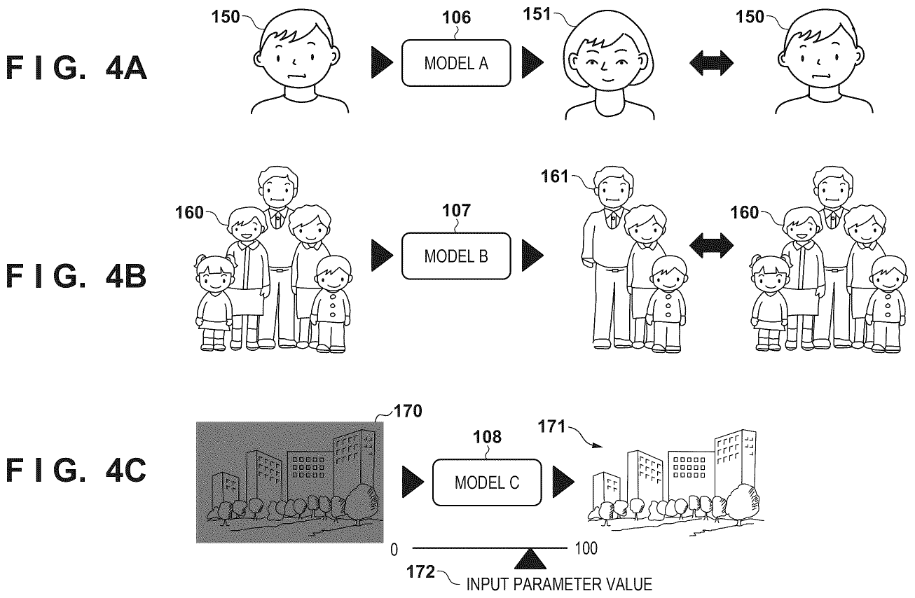

Subsequently, the calculation processing of the veracity according to the present embodiment will be described with reference to FIGS. 4A to 4C. FIG. 4A is an example in which the veracity calculation processing performed in step S142 in the processing flow of FIG. 3 is performed using similarity. When the model A 106 is selected in step S140, test data 150 is input to the model A 106, and a style converted image 151 is generated. The similarity of the image is calculated based on the style converted image 151 having been generated and the test data 150. Structural similarity (SSIM) is used for calculation processing of the similarity in the present embodiment. Mean pixel values of the style converted image 151 and the test data 150 are set as μₓ and μ_{y}, respectively, the variance is set as σₓ and σ_{y}, and the covariance is set as σ_{xy}. Use of constants C₁ and C₂, SSIM can be expressed by the following Equation (1).

$$\begin{matrix}[ Equation 1 ] & \\ SSIM = \frac{( 2 {μ}_{x} {μ}_{y} + {C}_{1} ) ( 2 {σ}_{x y} + {C}_{2} )}{( {μ}_{x}^{2} + {μ}_{y}^{2} + {C}_{1} ) ( {σ}_{x}^{2} + {σ}_{y}^{2} + {c}_{2} )} & ( 1 )\end{matrix}$$

The closer the SSIM is to 0, the lower the similarity is, and conversely, the closer the SSIM is to 1, the higher the similarity is. Therefore, the value calculated by Equation (1) may be used as the veracity. A numerical value in which the calculated similarity is converted into a percentage may be used as the veracity, or the calculated similarity may be divided into arbitrary intervals such that 0≤SSIM<0.2 represents a veracity rank A, and 0.2≤SSIM<0.4 represents a veracity rank B, and the veracity may be allocated to each divided range. The calculation method of the similarity is not limited to SSIM, and the similarity may be obtained from cosine similarity or a simple difference between pixel values. In the present embodiment, the veracity is obtained by calculating the similarity between the test data 150 having been input and the style converted image 151, but the veracity may be obtained by the similarity between the correct answer information assigned to the test data and the style converted image 151.

FIG. 4B is an example in which the veracity calculation processing performed in step S142 in the processing flow of FIG. 3 is performed using an area ratio of a change region. When the model B 107 is selected in step S140, test data 160 is input to the model B 107, and a region deleted image 161 is generated. The region deleted image 161 having been generated is compared with the test data 160, the ratio of the area of the deleted region in the region deleted image 161 to the area of the entire image is calculated, and the calculated area ratio is obtained as the veracity. For example, in a case where the area of the region deleted in the region deleted image 161 is 40% of the entire image, the area of the region not changed is 60%, and therefore the veracity is set as 60. In place of extraction of the deleted region, a neural network model learned for the purpose of object detection may be used, and the veracity may be obtained from the ratio between the number of detected objects detected in the test data 160 and the number of detected objects detected in the region deleted image 161.

FIG. 4C is an example in which the veracity calculation processing performed in step S142 in the processing flow of FIG. 3 is performed using a parameter value. When the model C 108 is selected in step S140, a parameter value 172 settable to the model C 108 is acquired. The parameter value 172 having been acquired is a value that affects a noise removed image 171, which is a generation result, when the noise removed image 171 is generated by inputting test data 170 to the model C 108, and is, for example, an adjustment parameter of the noise removal intensity. The value of this parameter value 172 can be a value of the veracity. As another calculation method of the veracity, the veracity may be obtained from the similarity of the noise removed image 171 generated with the parameter value 172 with reference to the veracity obtained from the similarity between the noise removed image generated with the upper and lower limit values of the settable parameter and the test data 170. The obtained veracity and the parameter value 172 may be recorded as the veracity evaluation information 109. Specific content will be described later.

### Text-to-Image

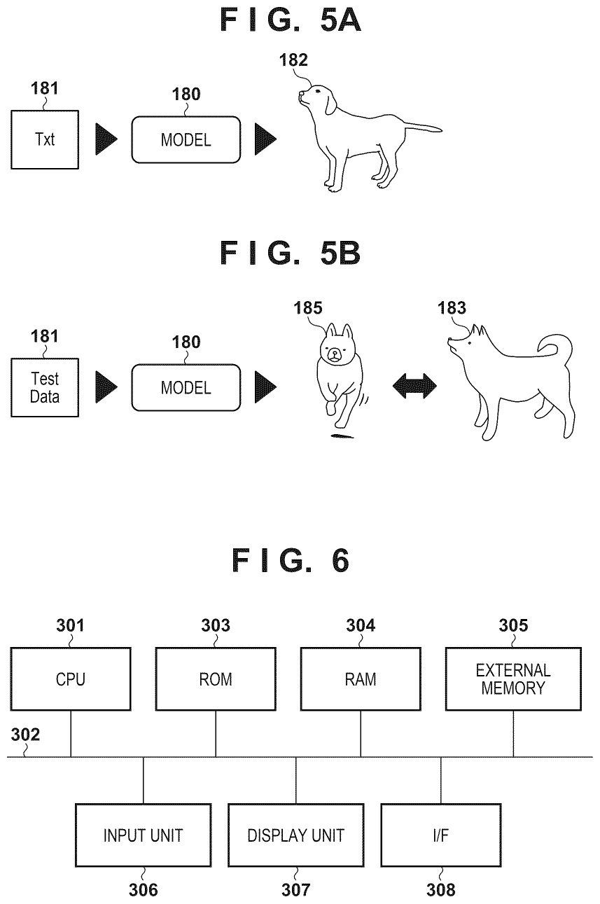

FIGS. 5A and 5B are explanatory views regarding the learned model that performs text-to-image. A model 180 will be described with reference to FIG. 5A. This model is a model for performing text-to-image, specifically, Txt 181 expressed by a character string such as alphanumeric characters and Japanese is input, and an image 182 is output based on the character string information having been input. This model 180 may be an NN model in which a text encoder and an image decoder are combined based on a transformer, or may be a diffusion-based NN model.

FIG. 5B is an example of the veracity calculation processing performed in step S142 in the processing flow of FIG. 3. The model 180 is selected in step S140, and test data 184 is acquired as test data in step S141. The test data 184 at this time is prompt information that is “white dog”, for example, and is assigned with a correct answer image 183 of “white dog” as correct answer information. In step S142, the test data 184 is input to the model 180, and a dog image 185 is generated.

The similarity of the image is calculated based on the dog image 185 having been generated and the correct answer image 183. The similarity may be calculated using SSIM similarly to the content described above. After the similarity is calculated, the veracity is calculated based on the calculated similarity. As another method regarding similarity calculation, object detection may be performed on the dog image 185 having been generated and the correct answer image 183, and the similarity may be calculated based on the detected result. The object detection may be performed using a CNN-based NN model learned to classify objects in an image by type.

### Description of Hardware Configuration

FIG. 6 is a block diagram illustrating the hardware configuration of the information processing system (or the information processing apparatus) according to the first embodiment. A CPU 301 controls various devices connected to a bus 302 and executes information processing. CPU is an abbreviation for central processing unit. A ROM 303 stores a BIOS program and a boot program. ROM is an abbreviation for read only memory.

A RAM 304 is used as a main storage apparatus of the CPU 301. RAM is an abbreviation for random access memory. An external memory 305 stores a program to be processed by the information processing apparatus 103. An input unit 306 is a keyboard or a mouse, and performs processing related to input of information. A display unit 307 outputs a computation result of the information processing apparatus 103 to the display apparatus in accordance with an instruction from the CPU 301. Note that the display apparatus may be of any type, such as a liquid crystal display apparatus, a projector, or an LED indicator. LED is an abbreviation for light emitting diode.

The bus 302 connects the CPU 301, the RAM 304, the ROM 303, and the external memory 305 in a manner that can communicate with one another.

An I/F 308 is an interface, performs information communication via a network, and performs communication between an information processing system 101 and an external system. The communication interface may be an Ethernet, and may be of any type such as USB, serial communication, and wireless communication.

### Functional Configuration

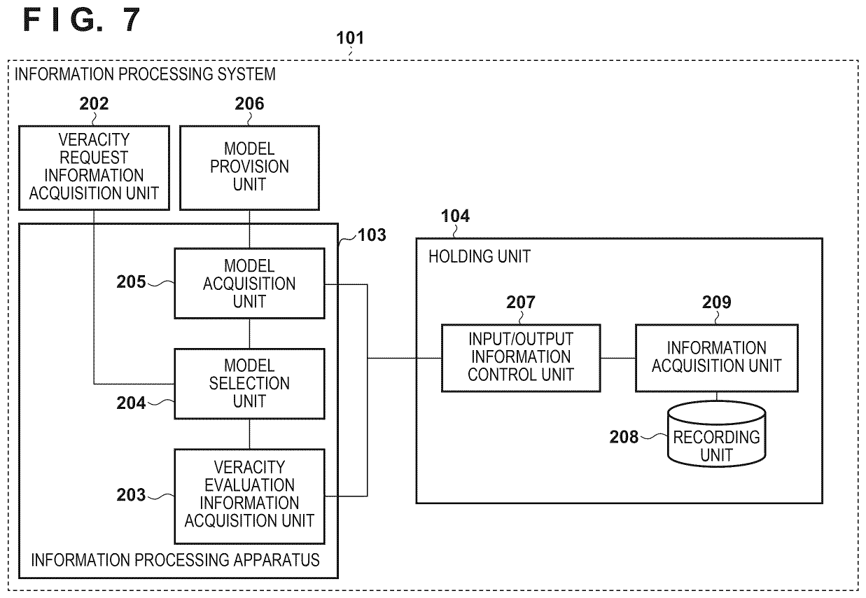

The functional configuration of the information processing system according to the present embodiment will be described with reference to FIG. 7. FIG. 7 is a block diagram illustrating the module configuration of the system according to the first embodiment.

The information processing system 101 includes the information processing apparatus 103, the holding unit 104, a veracity request information acquisition unit 202, and a model provision unit 206. The veracity request information acquisition unit 202 is an information acquisition apparatus for inputting the veracity requested by the user 102 to the information processing apparatus 103. The model provision unit 206 is an output apparatus for providing a learned model that can generate data serving as the veracity requested by the user 102. The information processing apparatus 103 includes a veracity evaluation information acquisition unit 203, a model selection unit 204, and a model acquisition unit 205. The holding unit 104 includes an input/output information control unit 207, a recording unit 208, and an information acquisition unit 209.

The veracity request information acquisition unit 202 acquires the veracity request information representing a request regarding the veracity input to the information processing system 101 (request acquisition). The veracity evaluation information acquisition unit 203 acquires the veracity evaluation information from the holding unit 104. The veracity evaluation information is a management table in which the model and the veracity are associated with each other, and details will be described later. The model selection unit 204 selects a learned model based on the veracity request information having been input and the veracity evaluation information having been acquired. The model acquisition unit 205 acquires a corresponding learned model from the holding unit 104 based on the information on the model selected by the model selection unit 204. Thereafter, the learned model having been acquired is provided to the user through the model provision unit 206. Specific content will be described later.

The holding unit 104 is connected to the information processing apparatus 103, inputs a request from the information processing apparatus 103, and outputs the veracity evaluation information or the learned model in response to the request. The input/output information control unit 207 controls input/output of information to/from the information processing apparatus 103. The recording unit 208 records, as the veracity evaluation information, a plurality of learned models and a table of the veracity calculated for each model. Specific content will be described later.

Note that in the example of FIG. 7, the information processing apparatus 103, the holding unit 104, the veracity request information acquisition unit 202, and the model provision unit 206 are depicted as separate bodies. However, the present disclosure is not limited to this example, and the information processing apparatus 103 may be configured to include at least some or all of the holding unit 104, the veracity request information acquisition unit 202, and the model provision unit 206.

### Processing Procedure and Detailed Processing Method

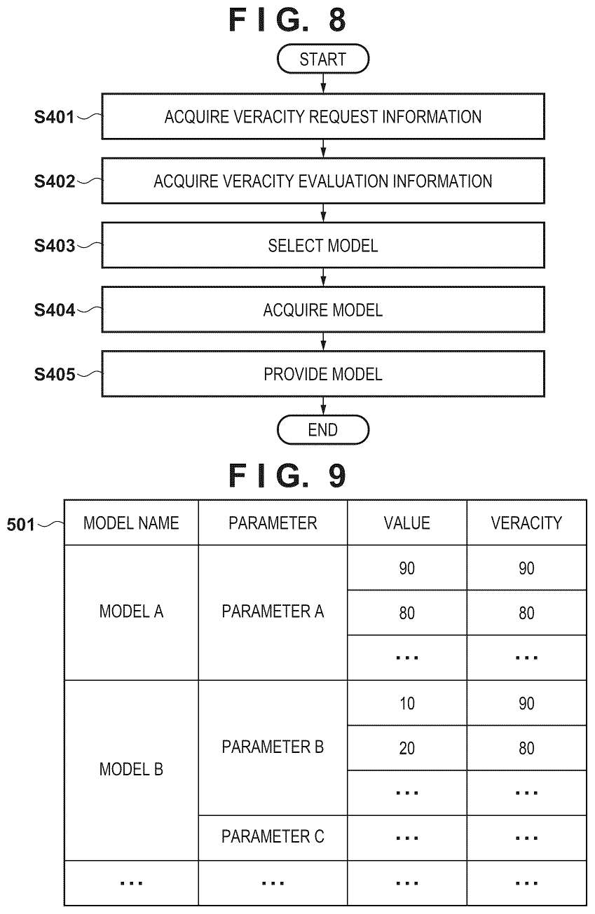

Next, the processing procedure and a detailed processing method of the information processing apparatus 103 according to the present embodiment will be described with reference to FIG. 8. FIG. 8 is a flowchart showing the flow of the entire processing to be executed by the information processing apparatus 103 illustrated in FIG. 7.

In step S401, the veracity request information acquisition unit 202 acquires the veracity request information 105, which is the request by the user 102 input to the information processing system 101 via the input unit 306. The veracity request information 105 in the present embodiment is the veracity input from the user 102, but is not limited to this. For example, it may be acquired from the veracity input in the past by the user 102. The veracity to be requested may be a specific numerical value or may be a numerical value that can designate a range including upper and lower limits.

In step S402, the veracity evaluation information acquisition unit 203 acquires the veracity evaluation information 109 from the holding unit 104. In the holding unit 104, the input/output information control unit 207 receives a request for content for outputting the veracity evaluation information 109 from the veracity evaluation information acquisition unit 203. Based on the request received by the input/output information control unit 207, the information acquisition unit 209 acquires the veracity evaluation information 109 from the recording unit 208 and transmits it to the input/output information control unit 207. The input/output information control unit 207 transmits the veracity evaluation information 109 having been received to the veracity evaluation information acquisition unit 203 in the information processing apparatus 103. The veracity evaluation information 109 in the present embodiment is held in the form of a management table in which a plurality of different learned models recorded in the holding unit 104 are associated with the veracity of the respective models.

In step S403, the model selection unit 204 selects a learned model that satisfies the request by the user 102 based on the veracity request information 105 and the veracity evaluation information 109. In a case where a plurality of learned models having the same veracity as the veracity included in the veracity request information 105 exist in the veracity evaluation information 109, all the learned models having the same veracity are selected. In a case where no learned model having the same veracity as the veracity included in the veracity request information 105 exists in the veracity evaluation information 109, the learned model recorded in the management table of the veracity evaluation information 109 is selected as the veracity having a numerical value higher than that of the veracity included in the veracity request information 105. At that time, a learned model recorded in the management table of the veracity evaluation information 109 may be selected as the veracity of the closest numerical value and the highest numerical value. Alternatively, in the case where no learned model having the same veracity as the veracity included in the veracity request information 105 exists in the veracity evaluation information 109, a learned model recorded in the management table of the veracity evaluation information 109 may be selected as veracity having a numerical value closest to that of the veracity included in the veracity request information 105 or veracity having a difference equal to or less than a predetermined value.

By acquiring the veracity and a threshold as the veracity request information 105 in step S401, a learned model matching the veracity requested by the user 102 within a range of the threshold may be selected from the veracity evaluation information 109.

In step S404, the model acquisition unit 205 acquires, from the holding unit 104, the learned model selected in step S403. In the holding unit 104, the input/output information control unit 207 receives the acquisition request for the learned model from the model acquisition unit 205. Based on the request received by the input/output information control unit 207, the information acquisition unit 209 acquires the requested learned model from the recording unit 208 and transmits it to the input/output information control unit 207. The input/output information control unit 207 transmits the received learned model to the model acquisition unit 205 in the information processing apparatus 103.

In step S405, the model provision unit 206 provides the user 102 with the learned model acquired in step S404. When provided, the learned models may be provided to the user 102 with priority based on the veracity. For example, a learned model having veracity close to the veracity requested by the user 102 may be preferentially provided to the user 102, or may be rearranged in the ascending/descending order of the veracity to be provided to the user 102.

### Effect

As described above, according to the present embodiment, the user can select an appropriate learned model based on the veracity from a plurality of different learned models.

### Modification Example 1

In the first embodiment, an example in which a learned model is selected from a management table in which a plurality of different learned models are associated with the veracity of the respective models, the management table being recorded as the veracity evaluation information, has been described. However, the learned model may have a plurality of parameters that affect data to be generated, and the veracity may also change due to a change in the generated data depending on the parameter value. Therefore, as the veracity evaluation information, a management table in which the change target parameter and the parameter value thereof are associated with each other in addition to the plurality of learned models and the veracity for the respective models may be prepared and selected from the management table. Specific content will be described with reference to FIGS. 8 and 9. Note that step S401, step S403, and step S404 in FIG. 8 are similar to the content of the respective processing described above, and thus description will be omitted.

Next, FIG. 9 is an example of the veracity evaluation information according to the present modification example. In step S402 of FIG. 8, the veracity evaluation information acquisition unit 203 acquires veracity evaluation information 501. This veracity evaluation information 501 is a management table in which the veracity of each of a plurality of learned models recorded in the holding unit 104 is associated with change target parameters changeable for the respective models and the values thereof. The change target parameter can include an adjustment parameter of the noise removal intensity or a classifier-free guidance (CFG) scale.

For example, association may be performed such as veracity 95 in a case where the value of the adjustment parameter of the noise removal intensity is 0.1 and veracity 91 in a case where the value of the adjustment parameter of the noise removal intensity is 0.2. The CFG scale is a numerical value that designates how faithfully an image is generated relative to a prompt. Control may be performed such that the value of the CFG scale is set to be large if it is desired to strongly reflect the prompt, and the value of the CFG scale is set to be small if image quality is emphasized. For example, association may be performed such as veracity 95 in a case of CFG scale=1 and veracity 80 in a case of CFG scale=2.

In step S405, the model provision unit 206 provides the user 102 with the learned model acquired in step S404 and the change target parameter related to the model and the value thereof from the veracity evaluation information 501 acquired in step S402.

This makes it possible to select, based on the change target parameter and the value thereof, the learned model that can generate the generation data serving as the veracity requested by the user 102 from among the plurality of different learned models. Therefore, even if the user 102 does not search for the parameter after selecting the learned model, it is possible to generate the generation data having the requested veracity.

### Modification Example 2

In the first embodiment, selection of a learned model is performed on the assumption that a management table in which a plurality of different learned models are associated with the veracity for the respective models is recorded in the holding unit 104 in advance as the veracity evaluation information 109. However, the veracity recorded in advance is a value calculated by the test data, and is not the veracity calculated based on the change target information (original data) that the user 102 actually desires to change. Therefore, even if the change target information is actually input to acquire a generation result after the learned model is selected, there can be a case where the veracity requested by the user 102 is not obtained. Therefore, in the present modification example, a method of calculating the veracity based on the change target information that the user 102 actually desires to change and selecting a learned model will be described. Specific content will be described with reference to FIGS. 8, 10, and 11. Note that step S402 to step S405 in FIG. 8 are similar to the content of the respective processing described above, and thus description will be omitted.

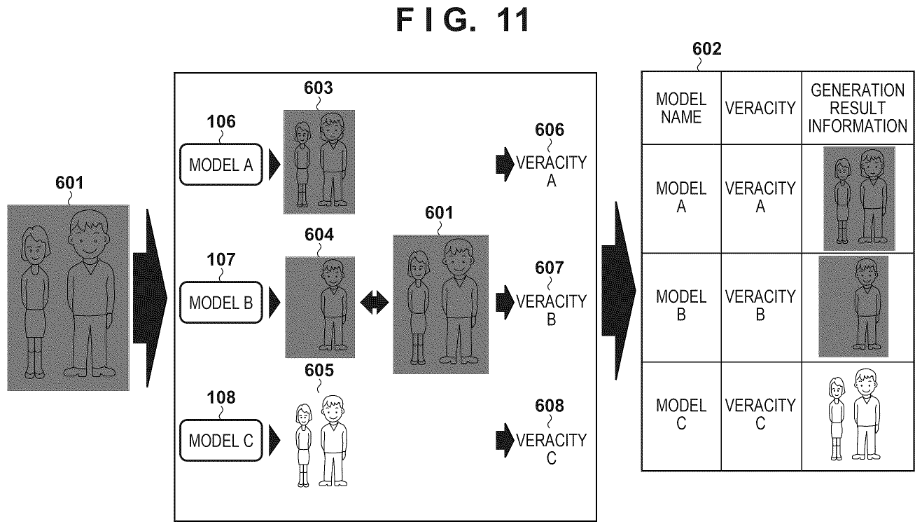

In step S401 of FIG. 8, the veracity request information acquisition unit 202 acquires the veracity requested by the user 102 as the veracity request information 105 and change target information 601 serving as a change target as illustrated in FIG. 11. The change target information 601 in the present embodiment is an image, but is not limited to this. For example, it may be audio data or may be text data.

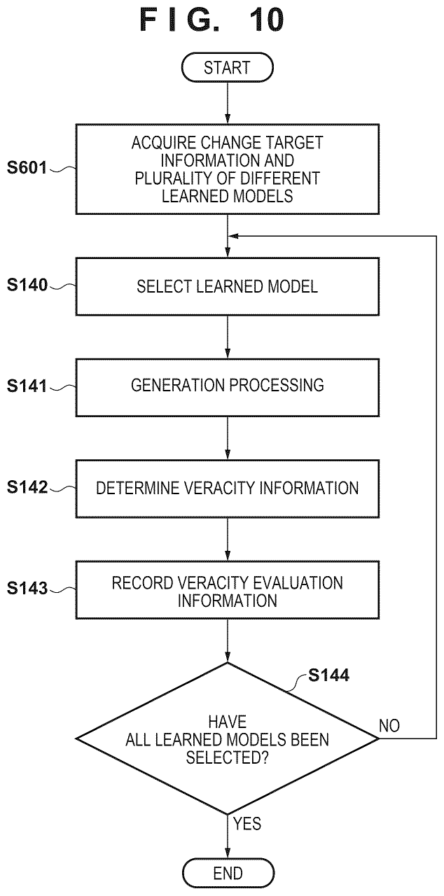

Next, FIG. 10 is a flowchart showing the procedure of the calculation processing of the veracity evaluation information according to the present modification example. The flowchart shows the flow of the veracity calculation regarding veracity evaluation information 602 to be acquired by the information acquisition unit 209 of the holding unit 104. Note that step S140 and step S142 to step S144 are similar to the respective processing described with reference to FIG. 3, and thus description will be omitted.

In step S601 of FIG. 10, the information acquisition unit 209 acquires the change target information 601 input to the input/output information control unit 207 and the model A 106, the model B 107, and the model C 108, which are a plurality of learned models recorded in the recording unit 208.

In step S141, the information processing apparatus 103 generates an image using the learned model selected in step S140. In the present embodiment, the change target information 601 acquired in step S601 is input to the learned model to perform generation of an image. Specific content will be described with reference to FIG. 11.

FIG. 11 is an explanatory view of an example regarding processing from step S140 to step S143. The change target information 601 acquired in step S601 is input to each of the model A 106, the model B 107, and the model C 108, and a style converted image 603, a region deleted image 604, and a noise removed image 605 are generated. Veracity A 606, veracity B 607, and veracity C 608 are obtained based on the generated images and the change target information 601, and recorded in the management table as the veracity evaluation information 602. Similarly, the style converted image 603, the region deleted image 604, and the noise removed image 605 having been generated are also recorded in the management table in association with the generated models.

This makes it possible to calculate not the test data but the veracity based on the change target information that the user 102 actually desires to change, and possible to select a learned model that further satisfies the request by the user 102.

### Second Embodiment

In the first embodiment, the method of selecting a learned model in an environment in which the information processing apparatus and the holding unit are provided in an identical information processing system and a plurality of learned models that are selection candidates are also recorded in the information processing system has been described. In contrast, in the present embodiment, a method of selecting a learned model in an environment in which a plurality of learned models that are candidates are recorded in a second information processing apparatus different from a first information processing apparatus present in an information processing system will be described. Details of the second information processing apparatus and detailed description on the selection method will be given later. Note that the hardware configuration in the second embodiment is similar to that in FIG. 6, the description will be omitted.

### Usage Form

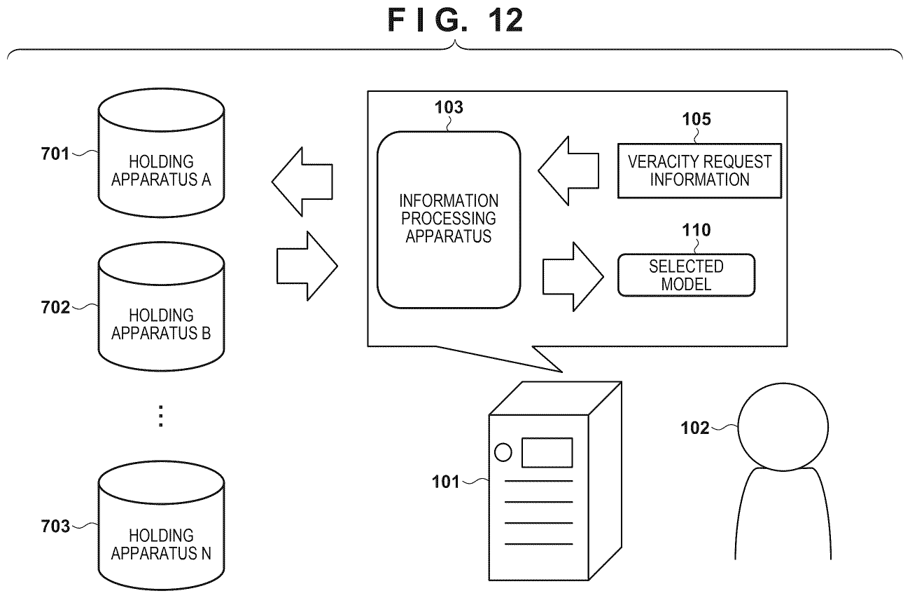

First, a usage form according to the second embodiment will be described with reference to FIG. 12. The information processing system 101 according to the present embodiment includes the information processing apparatus 103, and communicates with N holding apparatuses as the second information processing apparatus, which are set as, for the sake of explanation here, a holding apparatus A 701, a holding apparatus B 702, and a holding apparatus N 703. Note that the information processing system 101, the information processing apparatus 103, which is the first information processing apparatus, the veracity request information 105, and the selected model 110 are as described with reference to FIG. 1, and thus detailed description will be omitted.

The holding apparatus A 701, the holding apparatus B 702, and the holding apparatus N 703 each record a management table in which a plurality of different learned models and the veracity for the respective models are recorded in association with each other. The selected model 110 is selected from at least any one of the holding apparatus A 701, the holding apparatus B 702, and the holding apparatus N 703 based on the veracity request information 105 having been input.

### Functional Configuration

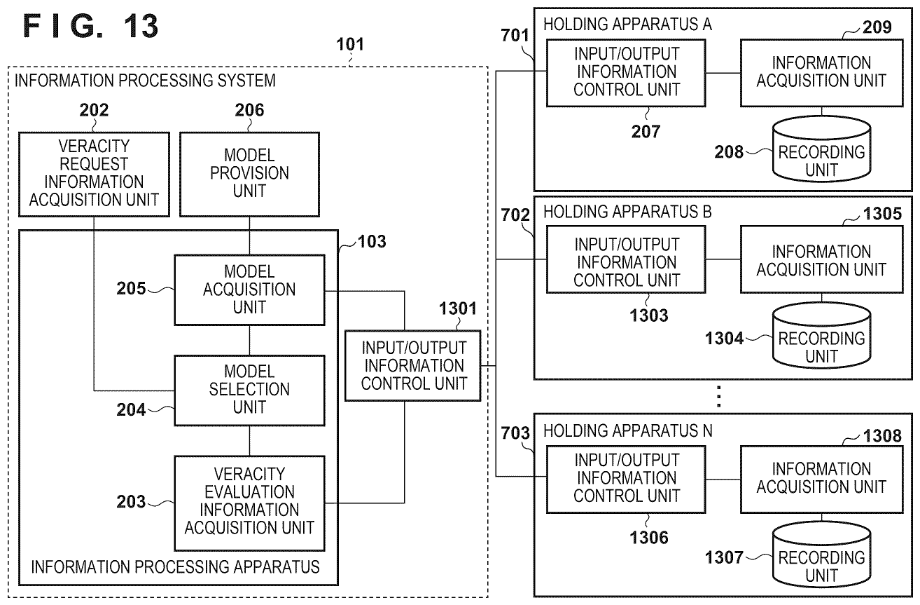

The configurations of the information processing system and the holding apparatus according to the second embodiment will be described with reference to FIG. 13. FIG. 13 is a block diagram of a case where there are N holding apparatuses of the module configuration of the system according to the second embodiment. The N holding apparatuses, which are the holding apparatus A 701, the holding apparatus B 702, and the holding apparatus N 703, as representatives for description here are connected via an input/output information control unit 1301 included in the information processing system 101. The holding apparatus A 701 has a similar configuration to that of the holding unit 104 described with reference to FIG. 7, and thus the description will be omitted. An input/output information control unit 1303, an input/output information control unit 1306, a recording unit 1304, a recording unit 1307, an information acquisition unit 1305, and an information acquisition unit 1308 present in the holding apparatus B 702 and the holding apparatus N 703 are similar to those in the holding apparatus A 701, the description will be omitted. Specific processing content will be described later.

Note that in the example of FIG. 13, the information processing apparatus 103, the veracity request information acquisition unit 202, the model provision unit 206, and the input/output information control unit 1301 are depicted as separate bodies. However, the present disclosure is not limited to this example, and the information processing apparatus 103 may be configured to include at least some or all of the veracity request information acquisition unit 202, the model provision unit 206, and the input/output information control unit 1301.

### Processing Procedure and Detailed Processing Method

Next, the processing procedure and a detailed processing method of the information processing apparatus 103 according to the present embodiment will be described with reference to FIGS. 8 and 13. Note that the processing in step S401 and step S403 in FIG. 8 is similar to the content described above, and thus description will be omitted.

In step S402 of FIG. 8, the veracity evaluation information acquisition unit 203 issues a request for acquiring the veracity evaluation information from another information processing apparatus different from the information processing apparatus 103 to the input/output information control unit 1301 in the information processing system 101. For example, the input/output information control unit 1301 acquires the veracity evaluation information from each of the holding apparatus A 701 and the holding apparatus B 702 based on a request, and transmits it to the veracity evaluation information acquisition unit 203. At the time of acquisition, communication with the holding apparatus A 701 and the holding apparatus B 702 may be performed from either side, or communication may be performed in parallel.

Similarly, the holding apparatus A 701 and the holding apparatus B 702 each include the input/output information control unit 207 and the input/output information control unit 1303. In the holding apparatus A 701, based on the received request, the information acquisition unit 209 acquires the veracity evaluation information from the recording unit 208, and transmits it to the input/output information control unit 207. Similarly, in the holding apparatus B 702, based on the received request, the information acquisition unit 1305 acquires the veracity evaluation information from the recording unit 1304, and transmits it to the input/output information control unit 1303.

The veracity evaluation information recorded in the holding apparatus A 701 is set as veracity evaluation information A 901, the veracity evaluation information recorded in the holding apparatus B 702 is set as veracity evaluation information B 902, and the details will be described in 149. The input/output information control unit 207 transmits the veracity evaluation information A 901 to the veracity evaluation information acquisition unit 203 in the information processing apparatus 103. Similarly, the input/output information control unit 1303 transmits the veracity evaluation information B 902 to the veracity evaluation information acquisition unit 203 in the information processing apparatus 103.

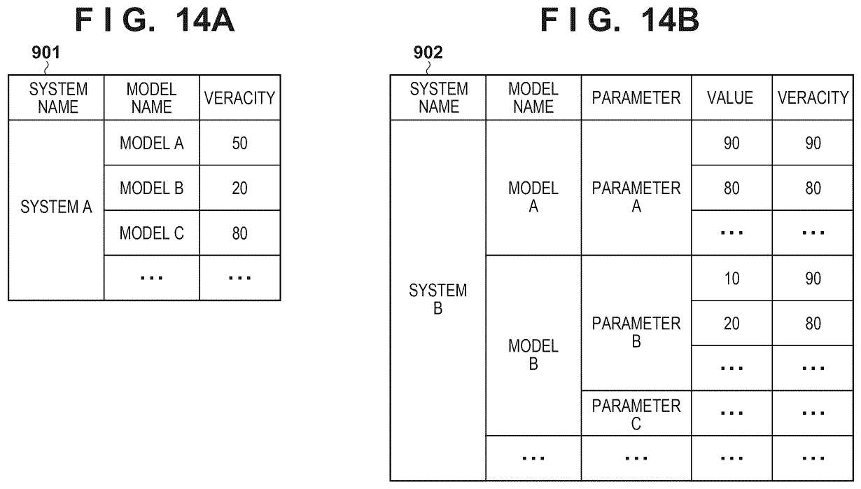

Here, FIGS. 14A and 14B are examples of the veracity evaluation information acquired by the veracity evaluation information acquisition unit 203 from the plurality of holding apparatuses in step S402. The veracity evaluation information acquired from the holding apparatus A 701 is set as the veracity evaluation information A 901, and the veracity evaluation information acquired from the holding apparatus B 702 is set as the veracity evaluation information B 902. The veracity evaluation information A 901 is a management table in which a plurality of different learned models are associated with the veracity of the respective models. The veracity evaluation information B 902 is a management table in which, in addition, change target parameters for the respective models and the values thereof are further associated with each other.

When the information acquisition unit 209 and the information acquisition unit 1305 acquire the veracity evaluation information A 901 and the veracity evaluation information B 902, respectively, the specific information on the holding apparatuses may be recorded in the management table in association with the veracity evaluation information. The specific information on the holding apparatuses is unique information such as an apparatus name, a company name providing the apparatus, and an IP address, and the apparatus name is recorded in the present embodiment.

In step S404, the model acquisition unit 205 requests the input/output information control unit 1301 to acquire the learned model selected in step S403 from the holding apparatus. Based on the request, the input/output information control unit 1301 acquires the learned model from at least one of the holding apparatus A 701, the holding apparatus B 702, and the holding apparatus N 703, and transmits it to the model acquisition unit 205. At the time of acquisition, communication with the holding apparatus A 701 and the holding apparatus B 702 may be performed from either side, or may be performed with priority according to the file size of the learned model. Communication may be performed in parallel. The holding apparatus A 701 and the holding apparatus B 702 receive, by the input/output information control unit 207 and the input/output information control unit 1303, respectively, information on the learned model requested from the model acquisition unit 205 of the information processing apparatus 103.

In the holding apparatus A 701, based on the request received by the input/output information control unit 207, the information acquisition unit 209 acquires the learned model from the recording unit 208 and transmits it to the input/output information control unit 207. The input/output information control unit 207 transmits the received learned model to the model acquisition unit 205 in the information processing apparatus 103. Similarly, in the holding apparatus B 701, based on the request received by the input/output information control unit 1303, the information acquisition unit 1305 acquires the learned model from the recording unit 1304, and transmits it to the input/output information control unit 1303. The input/output information control unit 1303 transmits the received learned model to the model acquisition unit 205 in the information processing apparatus 103.

In step S405, the model provision unit 206 provides the user 102 with the learned model acquired in step S404. When the learned models are provided, priority may be determined (prioritized) based on system information (specific information for specifying the system or the apparatus) included in the veracity evaluation information, and the learned models may be rearranged based on the priority and provided to the user 102. For example, the learned models may be rearranged in the ascending/descending order of the system names (or the apparatus names) to be provided to the user 102, or the system names selected by the user 102 in the past may be rearranged and displayed with priority.

### Effect

As described above, according to the present embodiment, since it is not necessary to store a plurality of learned models in the information processing apparatus, it is possible to provide a configuration with memory saving.

### Third Embodiment

In the first and second embodiments, a selection method in a case where an output destination of the selected learned model is the model provision unit 206 of the information processing system 101 has been described. In the present embodiment, a selection method of a learned model in a case where the output destination is the display unit of the information processing system 101 will be described. Specifically, a display UI system that displays, to the user 102, the veracity request information regarding the veracity requested by the user 102, the veracity evaluation information to be acquired from the holding unit 104, and the learned model selected by the model selection unit 204 will be provided. Detailed description of the content to be displayed will be given later.

Note that the usage form in the third embodiment is similar to that in FIG. 1, the description will be omitted. The hardware configuration in the third embodiment is similar to that in FIG. 6, the description will be omitted.

### Functional Configuration

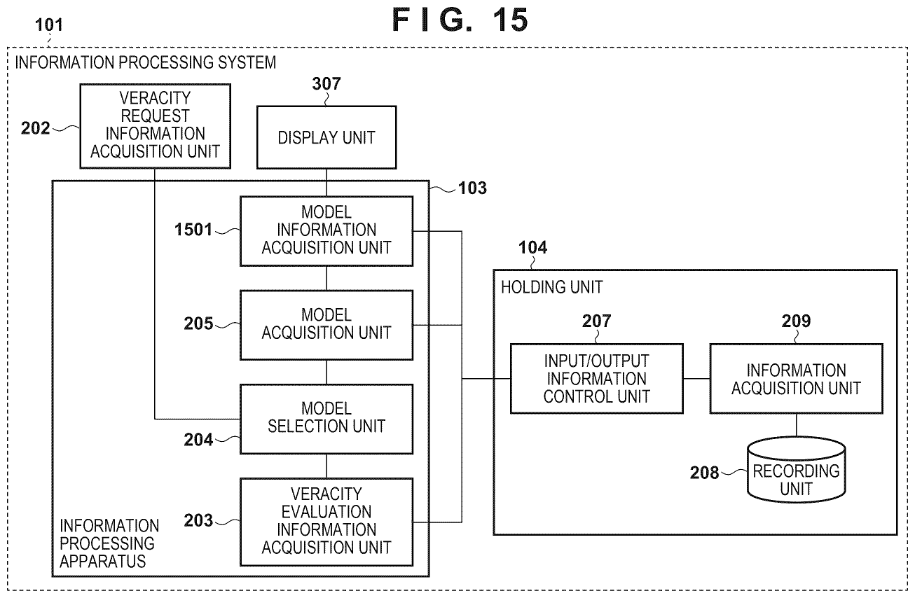

The functional configuration of the information processing apparatus according to the third embodiment will be described with reference to FIG. 15. FIG. 15 is a block diagram illustrating the module configuration of the information processing system according to the third embodiment.

The information processing apparatus 103 includes a model information acquisition unit 1501 in addition to the configuration elements described with reference to FIG. 7. In addition to the learned model selected by the model selection unit 204, the model information acquisition unit 1501 also acquires, from the holding unit 104, information related to the learned model. Details of the information to be acquired will be described later.

The display unit 307 provides the user 102 through the display UI system with the learned model acquired by the model acquisition unit 205 and information related to the learned model acquired by the model information acquisition unit 1501. A specific display method and display content will be described later.

Note that in the example of FIG. 15, the information processing apparatus 103, the holding unit 104, the veracity request information acquisition unit 202, and the display unit 307 are depicted as separate bodies. However, the present disclosure is not limited to this example, and the information processing apparatus 103 may be configured to include at least some or all of the holding unit 104, the veracity request information acquisition unit 202, and the display unit 307.

### Processing Procedure and Detailed Processing Method

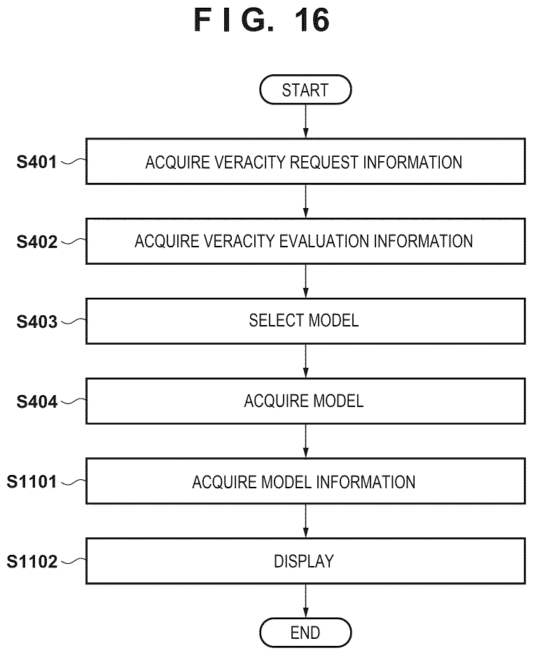

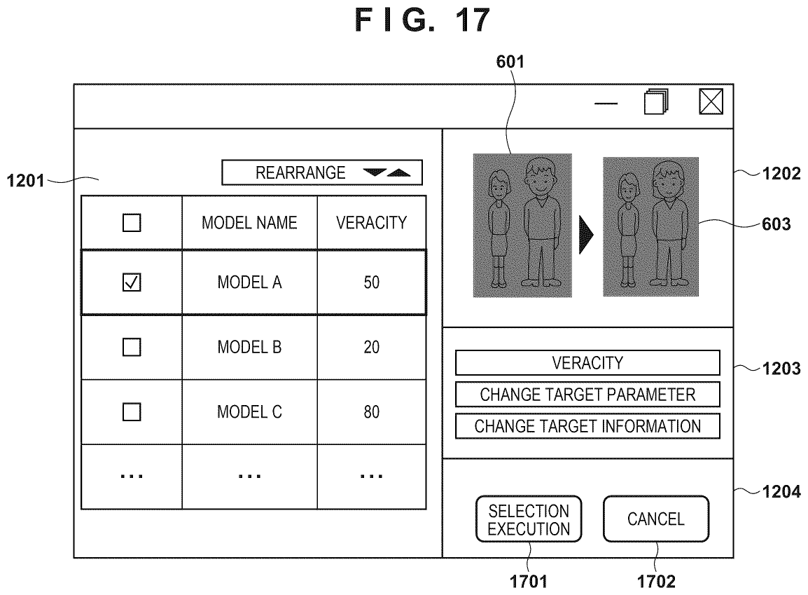

The processing procedure and a detailed processing method of the information processing apparatus 103 according to the present embodiment will be described with reference to FIGS. 16 and 17. FIG. 16 is a flowchart showing the flow of the entire processing in the present embodiment. Since each process from step S401 to step S404 is similar to the processing in FIG. 8, the description will be omitted.

In step S1101, the model information acquisition unit 1501 acquires, from the holding unit 104, information related to the learned model selected in step S403. The information related to the model may be, for example, time information such as a date and time when the corresponding learned model was recorded or an update date into the recording unit 208 in the holding unit 104, or may be information on a recorder who performed recording.

In step S1102, the display unit 307 notifies the display UI system of the learned model acquired by the model information acquisition unit 1501 in step S1101 and the information related to the model. Specific content to be notified will be described with reference to FIG. 17.

FIG. 17 is an example regarding a display screen of the display UI system to be provided to the user 102 through the display unit 307. The display UI system provides information by displaying, to the user, at least any one of the veracity request information acquired by the veracity request information acquisition unit 202, the veracity evaluation information acquired by the veracity evaluation information acquisition unit 203, and the learned model selected by the model selection unit 204. Furthermore, information related to the learned model acquired by the model information acquisition unit 1501 may be displayed.

In FIG. 17, a selection information display screen 1201 displays at least information on the learned model selected by the model selection unit 204 in step S403. The veracity of each model may be displayed from the veracity evaluation information 109 acquired in step S402, or a check box notifying of a user selection state of each model may be displayed so that the operation of the user 102 can be visualized. Date and time information and information on a recorder related to the model acquired by the model information acquisition unit 1501 in step S1101 may be displayed. Furthermore, a switching button that allows the user 102 to perform rearrangement with arbitrary priority based on the displayed information may be displayed.

A veracity-related information display screen 1202 displays the change target information (original data) included in the veracity request information 105 acquired in step S401 and the generation result image for each model included in the veracity evaluation information 109 acquired in step S402. In the present embodiment, display examples of the change target information 601 and the style converted image 603, which is the generation result information on the model A 106 in a selected state, are illustrated. The information to be displayed may be text, audio data, and the like, and is not limited to images.

The veracity request information input screen 1203 is an input form screen of the veracity request information 105 to be input by the user 102 via the input unit 306. On the input form screen, at least veracity to be requested, information on the change target parameter (e.g., an adjustment parameter of the noise removal intensity, a CFG scale, and the like), and change target information can be input via the screen. Input by the user 102 may be freely received on a text field, or a preset list may be displayed in a drop-down form and selected by the user 102.

A selection execution instruction screen 1204 includes at least a selection execution button 1701 for the information processing apparatus 103 to execute selection of the learned model and a cancel button 1702 for interrupting the execution processing. A button for downloading the learned model in a selected state on the selection information display screen 1201 to an arbitrary storage or server designated by the user 102 may be included.

### Effect

As described above, according to the present embodiment, it is possible to select a learned model that can generate data serving as the veracity requested by the user while visually checking it with the display UI system, and usability at the time of model selection is improved.

According to the present disclosure, it is possible to easily select a learned model that gives a generation result desired by the user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-179279, filed Oct. 11, 2024, which is hereby incorporated by reference herein in its entirety.

What is claimed is:

1. An information processing system comprising:
a holding unit configured to hold, in association with each other as evaluation information, a learned model and information indicating a degree of change in which a generation result generated by the learned model changes with respect to original data;
a request acquisition unit configured to acquire request information representing a request regarding the degree of change; and
a selection unit configured to select at least one learned model from among a plurality of learned models held in the holding unit based on the request information and the evaluation information.

2. The information processing system according to claim 1, wherein the request information includes information indicating the degree of change input by a user.

3. The information processing system according to claim 2, wherein the request information further includes original data to be input to the learned model.

4. The information processing system according to claim 3, wherein the original data includes an image, audio, text, or a 3D model.

5. The information processing system according to claim 2, wherein the request information further includes a change target parameter to be input to the learned model.

6. The information processing system according to claim 5, wherein the change target parameter includes an adjustment parameter of noise removal intensity or a classifier-free guidance (CFG) scale.

7. The information processing system according to claim 1, wherein the selection unit selects a learned model matching the request information.

8. The information processing system according to claim 7, wherein the selection unit selects all learned models matching the request information in a case where a plurality of learned models matching the request information exist.

9. The information processing system according to claim 7, wherein the selection unit selects a learned model closest to the request information in a case where no learned model matching the request information exists.

10. The information processing system according to claim 7, wherein the selection unit selects a learned model having a degree of change lower than the degree of change included in the request information in a case where no learned model matching the request information exists.

11. The information processing system according to claim 1 further comprising:
a model acquisition unit configured to acquire, from the holding unit, the at least one learned model selected by the selection unit; and
a providing unit configured to provide a user with the at least one learned model acquired by the model acquisition unit.

12. The information processing system according to claim 11, wherein the providing unit determines priority of the at least one learned model based on the degree of change, and rearranges, to provide a user with, the at least one learned model based on the priority.

13. The information processing system according to claim 1, wherein the holding unit holds, as the evaluation information, at least one of information indicating the generation result and a change target parameter to be input to the learned model in further association with each other.

14. The information processing system according to claim 1 further comprising:
a model information acquisition unit configured to acquire, from the holding unit, model information related to the at least one learned model selected by the selection unit; and
a control unit configured to causing a display unit to display the at least one learned model and the model information.

15. The information processing system according to claim 14, wherein the model information includes time information regarding a date and time when the learned model was recorded or information on a recorder who recorded the learned model.

16. An information processing system comprising a holding apparatus and an information processing apparatus, wherein
the holding apparatus includes
a holding unit configured to hold, in association with each other as evaluation information, a learned model and information indicating a degree of change in which a generation result generated by the learned model changes with respect to original data,
the information processing apparatus includes
a request acquisition unit configured to acquire request information representing a request regarding the degree of change,
an information acquisition unit configured to acquire the evaluation information, and
a selection unit configured to select at least one learned model from among a plurality of learned models held in the holding unit based on the request information and the evaluation information.

17. The information processing system according to claim 16, wherein the holding unit holds, as the evaluation information, specific information specifying the holding apparatus in further association with the evaluation information.

18. The information processing system according to claim 16 further comprising a plurality of holding apparatuses, wherein
the holding unit of the plurality of holding apparatuses holds, as the evaluation information, specific information specifying the holding apparatus in further association with the evaluation information,
the selection unit selects the at least one learned model from among a plurality of learned models held in the holding unit of the plurality of holding apparatuses based on the request information and the evaluation information, and
the information processing apparatus further includes
a providing unit configured to determine priority based on the specific information, and rearranging, to provide a user with, the at least one learned model selected by the selection unit based on the priority.

19. A control method of an information processing system comprising:
holding, in a holding unit, in association with each other as evaluation information, a learned model and information indicating a degree of change in which a generation result generated by the learned model changes with respect to original data;
acquiring request information representing a request regarding the degree of change; and
selecting at least one learned model from among a plurality of learned models held in the holding unit based on the request information and the evaluation information.

20. A non-transitory computer readable storage medium storing a program for causing a computer to execute a control method of an information processing system including
holding, in a holding unit, in association with each other as evaluation information, a learned model and information indicating a degree of change in which a generation result generated by the learned model changes with respect to original data
acquiring request information representing a request regarding the degree of change, and
selecting at least one learned model from among a plurality of learned models held in the holding unit based on the request information and the evaluation information.
